(19) United States
(12) Patent Application Publication
(10) Pub. No.: US 2008/0018135 A1
(43) Pub. Date: Jan. 24, 2008

(54) Hybrid dump body made of steel and aluminum

(75) Inventor: Randall Keith Risner, Salyersville, KY (US)

Correspondence Address: COATS & BENNETT, PLLC, 1400 Crescent Green, Suite 300, Cary, NC, 27518, US

(73) Assignee: R & S-Godwin Truck Body Company, LLC

(21) Appl. No.: 11/488,560

(22) Filed: Jul. 18, 2006

(51) Int. Cl. B62D 33/02

(52) U.S. Cl. 296/183.2

(57) ABSTRACT

A hybrid dump body comprises a main frame that includes a cross memberless frame structure of two spaced apart elongated members. Secured to the cross memberless frame is a steel bottom having a substantial flat portion and a pair of curved upturned side or edge portions. Secured to each curved edge portion of the steel bottom is an aluminum side wall or panel. Connected across the front of the hybrid dump body is a bulkhead that extends between the aluminum side panels and the steel bottom. Disposed about the rear of the dump body is a tailgate.

### FIELD OF THE INVENTION

The present invention relates to load beds and dump bodies, and more particularly to a hybrid load bed or dump body that is constructed of steel and aluminum.

### BACKGROUND OF THE INVENTION

Traditionally dump bodies on dump trucks and trailers have been constructed of steel. That is, the mainframe, bottom, sidewalls, bulkhead and tailgate have generally been of an all steel construction. Steel is, of course, rugged, durable and wear resistant, but with an all steel dump body comes substantial weight and this adversely affects fuel economy and load carrying capacity. For the trucking industry this normally means less profit. There have been attempts at reducing weight in dump bodies. For example, for many years the mainframe of dump bodies have been comprised of a series of longitudinal members and a series of cross members, with both the longitudinal and cross members being constructed of steel. There have been attempts at reducing the weight in the mainframe by eliminating the cross members and simply utilizing two spaced apart longitudinal members as a mainframe. This is commonly referred to as a cross memberless mainframe. Further, to deal with fuel economy and load carrying capacity, some dump bodies have used all aluminum components, and in some dump bodies having a mainframe, comprising both cross members and longitudinal members, the dump bodies have been constructed of part steel and aluminum. The shortcoming or disadvantage of using aluminum is the problem with wear. Aluminum does not have the wear resistance that is found in steel. When aluminum is used in the bottom of a dump bed on a dump truck, the bottom will be subjected to repeated poundings as dirt, rock and other debris are typically dumped from a height onto the bottom of the load bed. In addition, when the dump body is disposed in a dumping orientation, sliding dirt, rock and other debris down an aluminum bottom will impart substantial wear on the bottom of the dump body. In any event, the pounding and wear absorbed by an aluminum bottom will result in wear holes and spots that over time will require repairing. It is difficult to repair holes and wear spots cost effectively in a cross memberless mainframe dump body. There simply is not enough underlying structure to attach to in order to make repair feasible.

Therefore, there has been and continues to be a need for a dump body for a dump truck or trailer that provides good fuel economy and load carrying capacity, and at the same time, resists wear.

### SUMMARY OF THE INVENTION

The present invention relates to a hybrid dump body that is constructed of part steel and part aluminum components. The dump body of the present invention includes a cross memberless mainframe and a steel bottom having a flat central section and a pair of opposed curved, upturned sides. Bolted to upper portions of the curved, upturned sides of the steel bottom is a pair of aluminum side panels. Connected between the side panels is a bulkhead that forms a closed front portion of the dump body. Movably mounted to the rear portion of the dump body is a tailgate.

In addition, the present invention entails a method of constructing a hybrid dump body for a dump truck or trailer wherein various components of the dump body are constructed of steel and various components of the dump body are constructed of aluminum. In the case of one embodiment, the method entails forming a cross memberless mainframe that includes a pair of elongated sills or members. Secured to the elongated members is a steel bottom that includes a generally flat portion or section, and a pair of opposed, curved, and upturned edge portions. The method of construction includes bolting or securing lower portions of aluminum side panels to the upturned outer edge portions of the steel bottom. To close the dump body a bulkhead is connected transversely across the front of the dump body and a tailgate is secured across the back.

Other objects and advantages of the present invention will become apparent and obvious from a study of the following description and the accompanying drawings which are merely illustrative of such invention.

### BRIEF DESCRIPTION OF THE DRAWINGS

FIG. 1 is a perspective view of the hybrid dump body of the present invention.

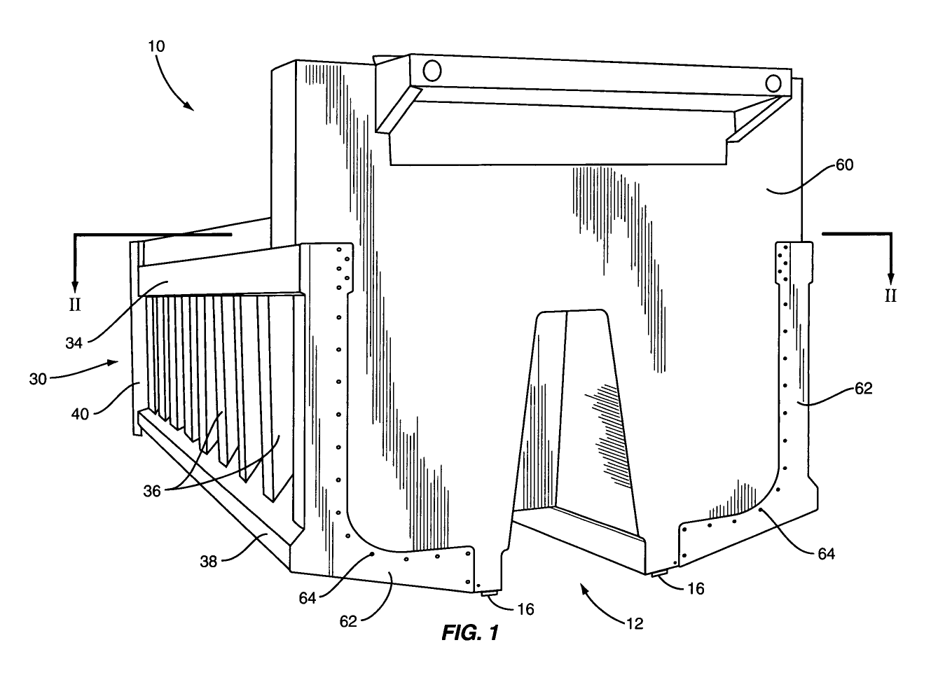

FIG. 2 is a sectional view taken along the line II-II of FIG. 1.

FIG. 3 is an enlarged view of an area shown in FIG. 2 and designated FIG. 3.

### DESCRIPTION OF THE INVENTION

With further reference to the drawings, the hybrid dump body of the present invention is shown therein and indicated generally by the numeral 10. The hybrid dump body 10 is utilized on a truck or trailer and is typically mounted such that it moves between a generally horizontal hauling position and an inclined dumped position. In the present invention, hybrid dump body 10 is constructed of both steel and aluminum. As will be appreciated from subsequent portions of the disclosure, the use of steel and aluminum in the dump body 10 is based on the objective of reducing the weight of the dump body 10 by using aluminum in strategic locations and utilizing steel in other heavy wear locations. This will, of course, reduce the weight of the dump body, provide better fuel economy, increase load carrying capacity, and, at the same time, will provide a durable and long-lasting composite dump body.

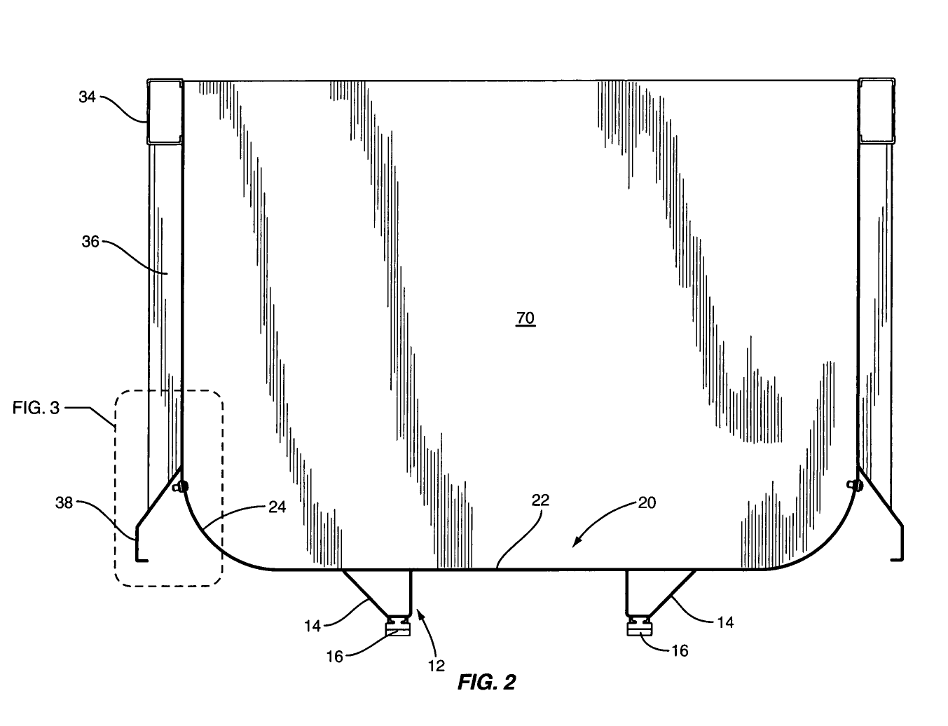

Turning more particularly to the hybrid dump body 10 of the present invention, the same includes a frame or mainframe that is indicated generally by the numeral 12. While various materials may be used to construct the frame 12, it is contemplated that the frame 12 would be constructed of steel. Frame 12 includes a pair of elongated longitudinal members 14 that extend in spaced-apart relationship from the front of the dump body 10 to the rear of the dump body. See FIG. 2. As seen in the drawings, secured to the underside of each longitudinal member 14 is a rubber insert 16. Frame 12 is described as a cross-memberless frame inasmuch as the frame does not include any significant or substantial cross-members interconnected to the longitudinal members 14. As used herein, the term “cross-memberless mainframe” means a frame structure for the hybrid dump body 10 that includes no cross-members or at least no cross-members that carry any significant or substantial load.

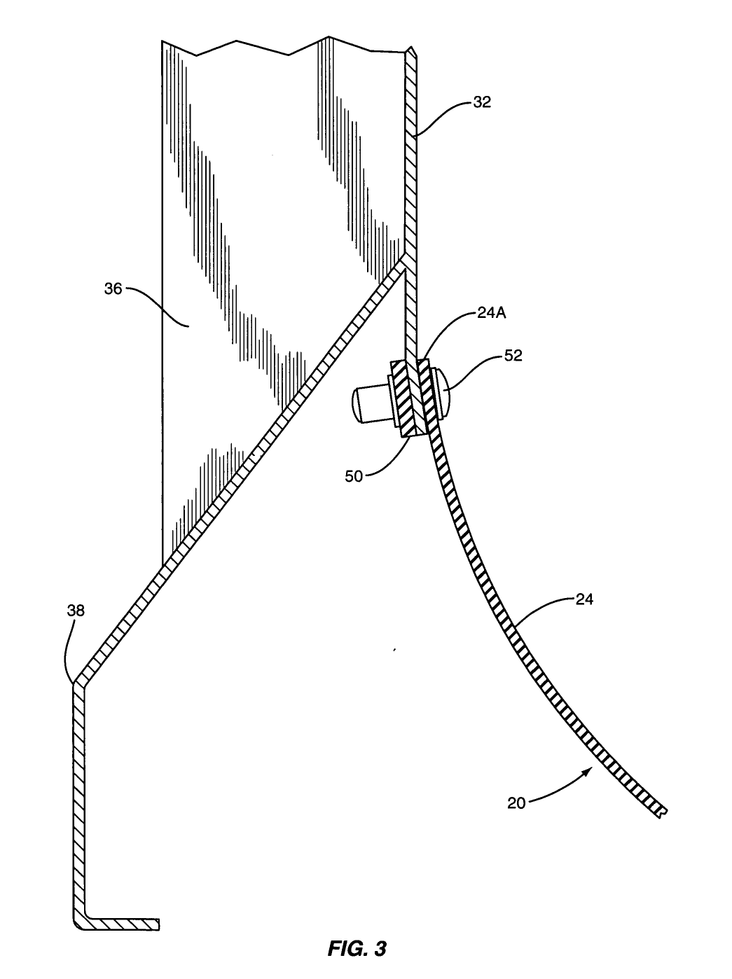

Secured to the frame 12 is a steel bottom indicated generally by the numeral 20. Various types of steel can be utilized, but in one embodiment, the steel utilized for the bottom is AR400 or AR450. As seen in the drawings, the steel bottom 20 includes a flat central section 22 that overlies the longitudinal members 14. Note that the flat central section 22 extends from the front of the dump body 10 to the rear of the dump body and that the flat central section 22 extends outwardly past the longitudinal members 14. Formed about opposite sides or edge areas of the steel bottom 20 is a pair of curved outer edge portions 24. Note in FIG. 3 where the outer edge portions of the steel bottom 20 curve upwardly and outwardly. Curved outer edge portions lie outwardly of the longitudinal members 14 and include an upper edge 24A. Edge 24A is substantially elevated with respect to the flat central section 22.

Secured to the bottom 20 is a pair of side panel assemblies, each being indicated generally by the numeral 30. Each side panel assembly 30 in this embodiment is constructed of aluminum. As seen in the drawings, each aluminum side panel assembly 30 is connected and supported, in substantial part at least, by one of the curved outer edge portions 24. Viewing each aluminum side panel assembly 30 in more detail, it is seen that the same includes a series of individual side panels 32. See FIG. 3. Reinforcement is provided for each side panel assembly 30 by a longitudinal top rail 34 and a series of vertical braces 36. Extending longitudinally along the lower portion of each aluminum side panel assembly 30 is a bottom rail or fender 38. Note that the bottom rail or fender 38 projects outwardly and downwardly from a portion of each aluminum side panel assembly 30. In addition, each aluminum side panel assembly 30 includes a rear post 40.

As illustrated in FIGS. 2 and 3, each aluminum side panel assembly 30 is secured to a curved edge portion 24 of the steel bottom 20. That is, each aluminum side panel assembly 30 extends upwardly from the curved outer edge portion 24. Note that the connecting points, or the areas where the aluminum side panel assemblies 30 are connected to the bottom 20, are elevated above the flat central section 22 of the bottom 20.

Each aluminum side panel assembly 30 can be connected to the bottom 20 in various ways. In the embodiment illustrated herein, each aluminum side panel assembly 30 is connected to the curved outer edge portions 24 through a series of fasteners, in this case, a series of bolt assemblies 52.

More particularly, there is provided an elongated fastening strip 50 that assists in connecting the aluminum side panel assemblies 30 to the bottom 20. While the fastening strip 50 may be constructed of various materials, in this embodiment the fastening strip 50 is constructed of steel. Note that each aluminum side panel assembly 30 includes a lower edge that is projected between one curved outer edge portion 24 and the fastening strip 50. In other words, the connecting portion of each aluminum side panel assembly 30 is sandwiched between the curved outer edge portion 24 of the bottom 20 and the fastening strip 50. A series of bolt assemblies 52 project through the curved edge portion 24, the aluminum side panel assembly 30, and the fastening strip 50. This effectively fastens the aluminum side panels 30 to the curved outer edge portions 24 of the bottom 20. It is seen that the curved outer edge portions 24 support side panel assemblies 30 from the bottom 20 and that, in the case of one embodiment, the side panel assemblies 30 are not connected directly to the frame 12.

Other means can be utilized to fasten the aluminum side panel assemblies 30 to the curved outer edge portions 24 of the bottom 20. For example, high performance adhesives can be utilized to secure the aluminum side panel assemblies 30 to the bottom 20. Further, processes generally known as clad metal bonding might be utilized to form this connection.

Extending across the front of the hybrid dump body 10 is a bulkhead 60. The bulkhead 60 can be constructed of steel or aluminum and is fastened or secured to both the bottom 20 and to the aluminum side panel assemblies 30. As illustrated in FIG. 2, the bulkhead 60 is secured to the front portion of each aluminum side panel assembly 30 by an aluminum fastening strip 62. Each aluminum fastening strip 62 is welded or otherwise secured to a front portion of one aluminum side panel assembly 30 and is turned generally 90° so as to extend over a portion of the front side of the bulkhead 60. A series of bolt assemblies 64 are secured through the aluminum fastening strips 62 and the bulkhead 60. This securely fastens the bulkhead 60 to the aluminum side panel assemblies 30 as well as to the bottom 20.

Secured transversely across the rear portion of the hybrid dump body 10 is a tailgate indicated generally by the numeral 70. Tailgate 70 is secured in conventional fashion between the aluminum side panel assemblies 30 and is movable between open and closed positions. Tailgate 70 can be constructed of various materials. To reduce the overall weight of the hybrid dump body 10, the tailgate 70 may be constructed of aluminum.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A hybrid dump body for a dump truck or trailer, comprising:
a. a cross memberless frame structure including at least two spaced apart and longitudinally extending support members;
b. a steel bottom connected to the cross memberless frame and having a flat central portion and a pair of curved outer portions;
c. a pair of opposed aluminum side panels with each aluminum side panel being secured to an outer curved portion of the steel bottom and extending upwardly therefrom;
d. a bulkhead; and
e. a tailgate.

2. The hybrid dump body of claim 1 wherein the tailgate is constructed of aluminum.

3. The hybrid dump body of claim 1 including a series of fasteners for securing each aluminum side panel to one curved outer portion of the steel bottom.

4. The hybrid dump body of claim 3 wherein the fasteners are longitudinally spaced along each curved outer portion of the steel bottom.

5. The hybrid dump body of claim 1 including a pair of elongated fastening strips, each fastening strip being outwardly spaced from one curved outer portion of the steel bottom and wherein a portion of each aluminum side panel is sandwiched between one curved outer portion of the steel bottom and the fastening strip.

6. The hybrid dump body of claim 5 including a series of fasteners extending through the curved outer portion of the steel floor, the aluminum side panel, and the fastening strip.

7. The hybrid dump body of claim 5 wherein the bulkhead is constructed of steel and the tailgate is constructed of aluminum.

8. The hybrid dump body of claim 1 wherein the longitudinally extending support members and bulkhead are constructed of steel, and the tailgate is constructed of aluminum.

9. The hybrid dumb body of claim 1 including a pair of aluminum connectors for connecting the bulkhead to the aluminum side panels.

10. The hybrid dump body of claim 1 including a series of spaced apart fasteners for fastening the aluminum side panels to the outer curved portions of the steel bottom, and wherein the fasteners are disposed at an elevation above the flat central portion of the bottom.

11. The hybrid dump body of claim 1 including a pair of elongated steel fastening strips, each steel fastening strip being outwardly spaced from one curved outer portion of the steel bottom, and wherein a lower portion of each aluminum side panel is sandwiched between one curved outer portion of the steel bottom and the steel fastening strip, and wherein there is provided a series of spaced apart fasteners extending through each curved outer portion of the steel floor, the adjacent aluminum side panel, and the steel fastening strip.

12. A method of constructing a hybrid dump body utilizing both steel and aluminum, comprising:
a. securing a steel bottom having opposed curved outer side portions to a steel cross memberless frame having a pair of longitudinally extending support members secured to the steel bottom;
b. attaching an aluminum side panel to each curved outer side portion of the bottom such that the aluminum side panels are not secured to any portion of the cross memberless frame;
c. securing a bulkhead across a front portion of the hybrid dump body; and
d. securing a tailgate across a rear portion of the hybrid dump body.

13. The method of claim 12 including securing a lower portion of each aluminum side panel between one of the curved outer side portions of the steel bottom, and an elongated fastening strip.

14. The method of claim 13 including connecting a series of fasteners between each elongated fastening strip and the adjacent curved outer side portion of the steel bottom.

15. The method of claim 14 wherein each fastener extends through one of the curved outer side portions of the steel floor, one aluminum side panel, and one elongated fastening strip.

16. The method of claim 12 wherein the steel bottom includes a flat portion and where the outer side portions of the steel bottom extend upwardly to a height above the flat portion of the steel bottom and wherein the aluminum side panels are connected to the outer curved side portions of the steel bottom at points above the flat portion of the steel bottom.

17. The method of claim 12 including connecting the bulkhead to the aluminum side panels via two aluminum connectors that extend from the aluminum side panels and connect to the bulkhead.

18. A hybrid dump body for a dump truck or trailer, comprising:
a. A main frame including two longitudinally-extending and spaced-apart members;
b. A steel bottom secured to the longitudinal members and having a flat section that overlies the two longitudinal members;
c. The steel bottom including a pair of opposed edge portions, each edge portion of the steel body extending outwardly from one of the longitudinal members and curved upwardly such that an edge thereof is elevated above the flat section of the steel body; and
d. A pair of aluminum side panels with each aluminum side panel secured to one curved edge portion of the bottom at points elevated above the flat section of the bottom such that each side panel is substantially supported by one of the curved edge portion of the bottom.

19. The hybrid dump body of claim 18 including a plurality of fasteners securing each side panel with one of the curved edge portions of the steel bottom such that each side panel is supported from the bottom by one curved edge portion of the steel bottom.

20. The hybrid dump body of claim 18 wherein the mainframe is a cross-memberless mainframe wherein the bottom and side panels are substantially supported only by the two longitudinal members and the mainframe includes no substantial support structure comprised of cross-members.
